(19) United States
(12) Patent Application Publication
(10) Pub. No.: US 2005/0211504 A1
(43) Pub. Date: Sep. 29, 2005

(54) Descent apparatus

(75) Inventor: Ronald William Arthur, Waurn Ponds (AU)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: Fallsafe Technology Pty. Ltd., Waurn Ponds (AU)

(21) Appl. No.: 10/520,090

(22) PCT Filed: Jul. 2, 2003
(86) PCT No.: PCT/AU03/00852

§ 371 Date: May 11, 2005

(30) Foreign Application Priority Data
Jul. 5, 2002 (AU) 2002950186

(51) Int. Cl. A62B 1/12

(52) U.S. Cl. 182/238

(57) ABSTRACT

A descent apparatus (13) for loads and/or persons. The apparatus includes a cable or rope (17) adapted to be fixed at an elevated location with the remainder of the cable or rope being wound around a pulley (12) rotatably mounted within a housing (11) via an axle shaft (13). The housing (11) is adapted to be attached to the load and/or person and the relative rotation between the pulley (12) and the axle shaft (13) is controlled by a closed circuit gear pump (14) the gears (25, 26) of which form transmission means between the pulley (12) and the axle shaft (13). The closed gear pump forms part of an hydraulic circuit which contains a speed control mechanism (33) provided by an orifice (30) in the hydraulic circuit which forms a constriction to control the speed of the pump and thus the seed of rotation of the pulley about the axle shaft and as a consequence the speed of the descent of the descent apparatus (10) as the cable or rope unwinds from the pulley. The speed control mechanism can also include a valve member (34) co-operating with a mating seat (35) in an end of the orifice, whilst the position of the valve member (34) is adjustable relative to its seat by a grub screw (36) to adjust the rate of flow of hydraulic fluid through the closed circuit gear pump and as a consequence the speed of descent of the descent apparatus.

### TECHNICAL FIELD

This invention relates to an apparatus to enable persons or loads to descend from elevated locations, such as, from high rise buildings in emergency situations; from cliff faces in rescue operations; or for use by defence personnel or rescue personnel when descending from helicopters; although the apparatus is applicable to any situation where a person, or for that matter equipment or other loads, is to be lowered at a controlled rate from an elevated location.

### BACKGROUND ART

The essence of the apparatus of the present invention rests with the use of a cable or rope anchored at the elevated location and wound around a pulley apparatus connected to the person or load and from which the cable or rope unwinds from at a controlled rate as the person or load descends from the elevated location.

Although descent apparatus utilising cables or ropes are known, but not necessarily commonly known, such require some degree of training and experience in controlling the rate of descent, and thus are not suitable for escape or rescue operations where, not only due to the persons likely to be inexperienced, but are also in a severely stressful situation, involving a degree of panic and fear generated by the danger to which they are subjected, in the case, for example, of a fire in a high rise building, coupled with the necessity to escape from a particularly high location which in itself presents its own fears. In addition, in cases where persons concerned are injured or even unconscious or semi-conscious, and therefore not in a condition to control the rate of descent, then they are totally reliant on the apparatus to lower them to the ground and also control their rate of descent.

Other apparatus which have been proposed include the use of flexible chutes, but such apparatus has its limitations with regard to the height over which they can operate and other difficulties particularly with escape from high rise buildings where fires at lower levels within the building not only involve the existence of flames, but also the creation of unstable conditions adjacent the faces of the building as a result of updraughts of hot air.

One other descent apparatus or system is disclosed in International patent publication no. WO89/00063 in connection with which the inventor associated with this present application was a co-inventor, and involved the use of a cable or rope of twisted configuration and surrounded by a lowering device having an inner rotatable means engaging the cable or rope to follow the twist therein and thereby rotate about the cable or rope as it descends down the cable or rope. The inner rotatable means was rotatably supported within an outer housing having means to support a load, e.g. a person, therefrom, and means were provided to control the speed of rotation of the inner rotatable means and as a consequence the rate of descent of the lowering device down the cable or rope. With such an apparatus, although the inner rotatable means was free to rotate about the cable or rope as it descended, the weight of the load or person suspended from the outer housing held the outer housing against uncontrolled rotation about the cable or rope and thus the load or person being lowered maintained a fixed position relative to, and supported by, the cable or rope during the descent down the cable or rope.

In this previous patent publication a number mechanisms for controlling the speed or rotation of the inner rotatable means was disclosed, including the use of a closed circuit gear pump driven by the inner rotatable means and forming part of a hydraulic circuit containing a constriction to control the speed of the pump and therefore the speed of rotation of the inner rotatable means, and as a consequence the speed of descent.

Although this apparatus had been trialed and tested it has never been commercialised, and could not be said to be commonly known in the art of descent apparatus, devices or systems.

Although in principal the device achieved the objective required its application was complicated by the requirement for a special twisted cable or rope and the necessity to anchor the lower end of the cable or rope to the ground surface below.

It is therefore an object of the present invention to provide a descent apparatus for a load or person which in itself can control the rate of descent of the load or person, and which is not unduly affected by the conditions in which it may be required to operate, and in addition utilising a cable or rope fixed at an elevated location from which the apparatus is directly suspended with the cable or rope unwinding at a controlled rate as the load or person descends, rather than an apparatus following a twisted configuration of a cable or rope which in turn has to have its lower end anchored at ground level in order to operate.

### DISCLOSURE OF THE INVENTION

The invention therefore envisages a descent apparatus for loads and/or persons, said apparatus including a cable or rope having one end adapted to fixed at an elevated location with the remainder of the cable or rope being wound around an inner pulley rotatably mounted within an outer housing via an axle shaft, wherein the outer housing is adapted to be attached directly to the load and/or person, and wherein the relative rotation between the inner pulley and the axle shaft is controlled by a closed circuit gear pump the gears of which form transmission means between the inner pulley and the axle shaft, said closed circuit gear pump forming part of a hydraulic circuit containing a constriction to control the speed of the pump and thus the speed of rotation of the inner pulley about the axle shaft and as a consequence the speed of descent of the descent apparatus as the cable or rope unwinds from the inner pulley.

Preferably the size of the constriction is fixed so as to provide a single predetermined speed of descent.

Alternatively the size of the constriction may be variable to provide for different speeds of descent.

### BRIEF DESCRIPTION OF THE DRAWINGS

One preferred embodiment of the invention will now be described with reference to the accompanying drawings, in which

FIG. 1 is a schematic perspective view of the descent apparatus of this preferred embodiment of the invention,

FIG. 2 is a cross-sectional view taken along line 2-2 of FIG. 1,

FIG. 3 is a cross-sectional view taken along line 3-3 of FIG. 2,

FIG. 4 is a cross-sectional view taken along line 4-4 of FIG. 3, and

FIG. 5 is a cross-sectional view taken along line 5-5 of FIG. 3.

### BEST MODE FOR CARRYING OUT THE INVENTION

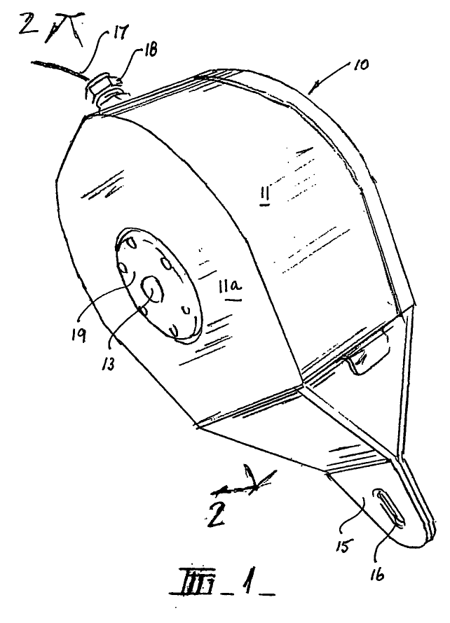

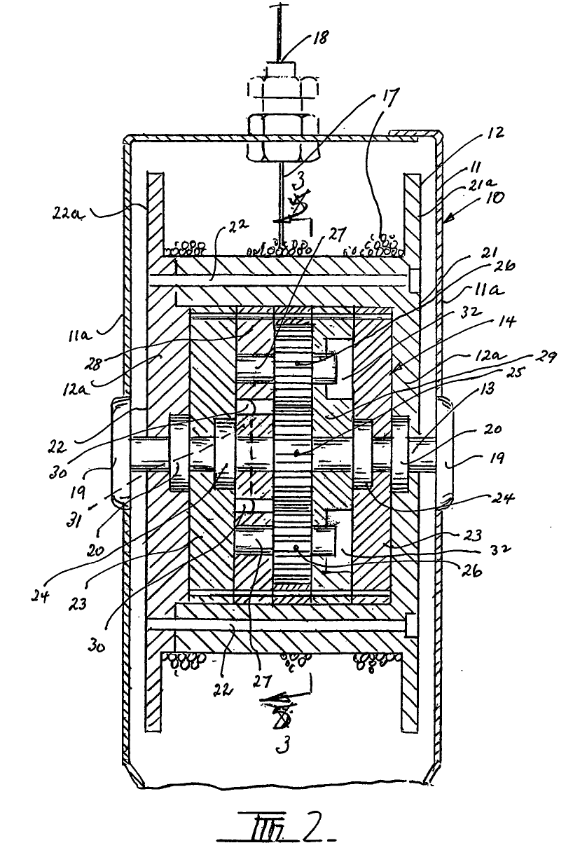

With reference to FIGS. 1 and 2 of the drawings, the descent apparatus of this preferred embodiment of the invention, and generally indicated as 10, comprises an outer housing 11 within which is rotatably mounted an inner pulley 12 via an axle shaft 13 and between which a closed circuit gear pump transmission assembly, generally indicated as 14, is incorporated to control the rotation of the inner pulley around the axle shaft 13. The outer housing has a coupling lug 15 with a hole 16 therethrough by which to suspend a load, such as a person, via a harness (not shown) and a detachable coupling (also not shown).

A cable or rope 17 is wound around the inner pulley 12 and is of a total length sufficient to extend from an elevated fixed position at one end of the cable or rope down to a lower level, such as a ground level, when the cable or rope is unwound or at least partially unwound from the pulley. The cable or rope 17 exits from the outer housing through an exit port 18 and its end is fixed to a structure at the elevated location, and when the cable or rope is fully wound onto the pulley the apparatus is immediately adjacent the point of fixation at the elevated location. As the apparatus, with the load or person suspended therefrom, descends/drops/falls from the elevated location the cable or rope unwinds from the pulley.

The rate of descent is controlled by the closed circuit gear pump transmission 14 which will now be described. The axle shaft 13 is fixed at either end to sidewalls 11a of the outer housing 11 by fixing means 19, whilst roller bearings 20 support side walls 12a of the inner pulley about the axle shaft 13 to allow the pulley to rotate about the shaft. The pulley consists of a cup-shaped member 21 including one of the side walls 12a, whilst bolts 22 interconnect the cup-shaped member 21 to a closure member 22 which includes the other sidewall 12a. The members 21 and 22 have radially outwardly extending flanges 21a and 22a respectively between which a space is defined to retain the cable or rope 17 around the pulley. The cup-shaped member 21 together with the closure member 22 define an inner cavity which receives the closed circuit pump transmission 14.

The closed circuit gear pump transmission has circular end walls 23 with roller bearings 24 allowing free rotation of the gear pump assembly about the axle shaft 13.

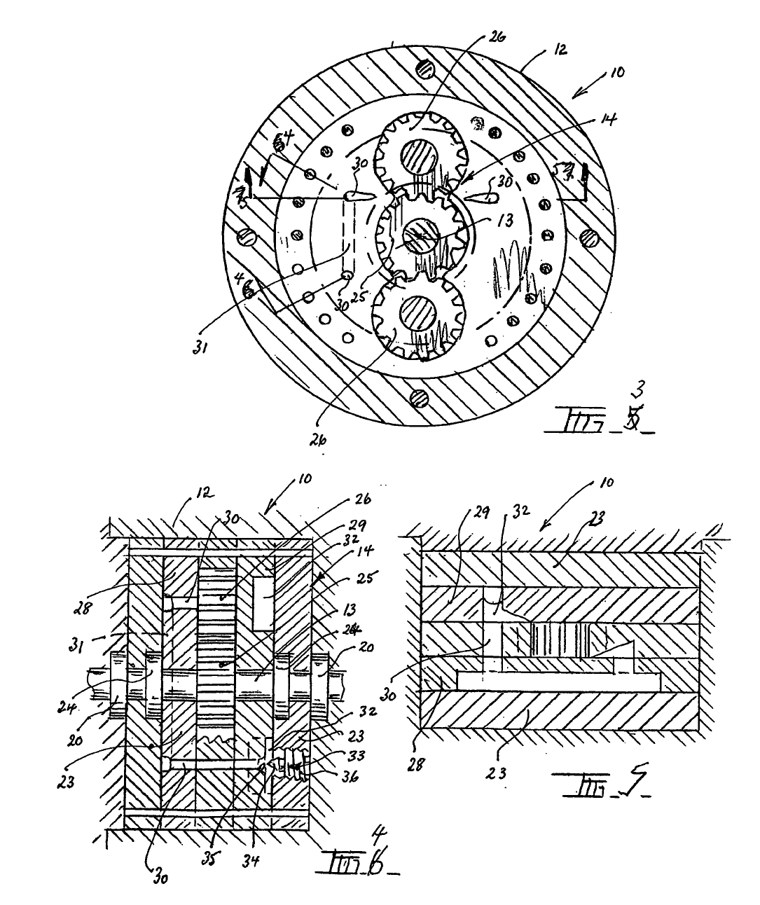

With reference to FIGS. 2 to 5 of the drawings, the gear pump transmission comprises a central sun gear 25 fixed to the axle shaft 13, and in driving engagement with two diametrically opposed planet gears 26 which in turn are mounted on pinions 27 retained at either sides of the planet gear in a pair of mounting plates 28 and 29 between which the gear train is sandwiched. As a consequence the outer housing 11, the axle shaft 13 and the sun gear 25 are all fixed together and remain stationery in space, whilst the pulley 12, the end walls 23, the mounting plates 28 and 29, and the planet gears 26 rotate in unison about the axle shaft 13 and the sun gear 25 and within the outer housing 11.

A series of orifices 30 and cavities 32 are provided through the mounting plates 28 and 29 with an interconnecting channel 31, and which all allow for hydraulic fluid to be pumped by the gear pump through a closed circuit within the gear pump assembly.

As the pulley rotates and the cable or rope unwinds therefrom, the pulley, the end walls 23, the mounting plates 28 and 29 and the planet gears 26 rotate about the sun gear 25 whereby the gear train acts as a gear pump pumping hydraulic fluid through a closed circuit, the path of which includes the spaces between the gears, the orifices 30, the channel 31 and cavities 32.

The gear pump in itself, having to pump fluid through a closed circuit, offers some resistance to rotation of the planet gears 26, and therefore the pulley 12, about the sun gear 25, the axle shaft 13 and within the housing 11, and therefore controls to some degree the rate of descent of the apparatus. However, in order to achieve control over the speed of descent, a speed control mechanism 33 is provided which consists of a conical valve member 34 cooperating with a mating seat 35 in the end of one of the orifices 30 through the mounting plate 29, thus forming a constriction. The valve member is carried by a grub screw 36 which can adjust the position of the valve member and set the amount of constriction and therefore the rate of flow of hydraulic fluid through the closed circuit, and when necessary the position of the valve member and the size of the constriction can be adjusted via the grub screw to vary the controlled speed of descent.

Since modifications within the spirit and scope of the invention may readily be effected by persons skilled within the art, it is to be understood that this invention is not limited to the particular embodiment described by way of example hereinabove.

1. A descent apparatus for loads and/or persons, said apparatus including a cable or rope having one end adapted to be fixed at an elevated location with the remainder of the cable or rope being wound around an inner pulley rotatably mounted within an outer housing via an axle shaft, wherein the outer housing is adapted to be attached directly to the load and/or person, and wherein the relative rotation between the inner pulley and the axle shaft is controlled by a closed circuit gear pump the gears of which form transmission means between the inner pulley and the axle shaft, said closed circuit gear pump forming part of a hydraulic circuit containing a constriction to control the speed of the pump and thus the speed of rotation of the inner pulley about the axle shaft and as a consequence the speed of descent of the descent apparatus as the cable or rope unwinds from the inner pulley.

2. A descent apparatus as claimed in claim 1, wherein the size of the constriction is fixed so as to provide a single predetermined speed of descent.

3. A descent apparatus as claimed in claim 1, wherein the size of the constriction may be variable to provide for different speeds of descent.

4. A descent apparatus as claimed in claim 1, wherein the inner pulley includes a cup-shaped member having an open end closed by a closure member both of which members carry radially outwardly extending flanges between which a space is defined to retain the cable or rope around the pulley.

5. A descent apparatus as claimed in claim 4, wherein the cup-shaped member and the closure member define an inner cavity which contains said closed circuit gear pump.

6. A descent apparatus as claimed in claim 1, wherein the closed circuit gear pump includes a central sun gear and a plurality of diametrically opposed planet gears.

7. A descent apparatus as claimed in claim 6, wherein the sun and planet gears are rotably sandwiched between members which include a series of orifices and cavities and interconnecting channels through which hydraulic fluid for the hydraulic circuit is pumped through the closed circuit gear pump.

8. A descent apparatus as claimed in claim 7, wherein the constriction is provided in one of the orifices, cavities or channels.

9. A descent apparatus as claimed in claim 8, wherein the constriction is provided by one of the orifices through one of the members which sandwich the sun and the planet gears.

10. A descent apparatus as claimed in claim 9, wherein the constriction is provided by a valve member co-operating with a mating seat in the end of said orifice.

11. A descent apparatus as claimed in claim 10, wherein the position of the valve member relative to its seat is adjustable to thereby control the rate of flow of hydraulic fluid through said closed circuit fluid pump and the speed of descent of the descent apparatus.

12. (canceled)
